(19) United States
(12) Patent Application Publication
(10) Pub. No.: US 2025/0300199 A1
(43) Pub. Date: Sep. 25, 2025

(54) FUEL CELL HYDROGEN GAS CIRCUIT DEVICE AND CONTROL METHOD THEREOF

(71) Applicant: SHANDONG UNIVERSITY OF SCIENCE AND TECHNOLOGY, Qingdao (CN)

(72) Inventors: Ziliang ZHAO, Qingdao (CN); Bin GUO, Qingdao (CN); Haoyi YU, Qingdao (CN); Zhangu WANG, Qingdao (CN); Jun ZHAO, Qingdao (CN); Yifan FU, Qingdao (CN); Senhao SHEN, Qingdao (CN)

(21) Appl. No.: 18/892,547

(22) Filed: Sep. 23, 2024

(30) Foreign Application Priority Data
Mar. 21, 2024 (CN) 202410322935.5

(51) Int. Cl. H01M 8/04119; H01M 4/92; H01M 8/04082; H01M 8/04089; H01M 8/04111; H01M 8/04223; H01M 8/04746; H01M 8/04858; H01M 8/04992; H01M 8/10

(52) U.S. Cl. CPC H01M 8/04179; H01M 4/92; H01M 8/04097; H01M 8/04111; H01M 8/04201; H01M 8/04231; H01M 8/04753; H01M 8/0494; H01M 8/04992; H01M 2008/1095; H01M 2250/20

(57) ABSTRACT

A fuel cell hydrogen gas circuit device and a control method thereof are provided. The device includes a hydrogen cylinder, a hydrogen pressure stabilizing chamber, an injector, a hydrogen-water separator, and a hydrogen circulation pump. The hydrogen cylinder is connected to the first inlet of the injector through the hydrogen pressure stabilizing chamber, and the outlet of the injector is connected to the inlet of the fuel cell stack. The outlet of the fuel cell stack is connected to the hydrogen-water separator, and the gas outlet of the hydrogen-water separator is connected to the second inlet of the injector. The hydrogen-water separator is also connected to the inlet of the hydrogen circulation pump, and the outlet of the hydrogen circulation pump is connected to the inlet and outlet of the fuel cell stack through pipelines. It can effectively alleviate hydrogen starvation under loading conditions, water flooding, and platinum degradation.

### CROSS-REFERENCE TO RELATED APPLICATIONS

This application claims priority to Chinese Application No. 202410322935.5, filed on Mar. 21, 2024 entitled “FUEL CELL HYDROGEN GAS CIRCUIT DEVICE AND CONTROL METHOD THEREOF”. These contents are hereby incorporated by reference.

### TECHNICAL FIELD

The present invention relates to the technical field of fuel cell, in particular to a fuel cell hydrogen gas circuit device and a control method thereof.

### BACKGROUND

Under the background of the “dual carbon” strategy, fuel cell vehicles have experienced rapid development. With the continuous development of hydrogen supply, hydrogen production, and hydrogenation technologies, how to improve the utilization rate of hydrogen has received widespread attention. In addition, for the fuel cell vehicle on-board application scenarios, for example, as the change of vehicle loading and unloading conditions, there will be hydrogen starvation, water flooding, platinum catalyst degradation and other problems during the use of fuel cells, and the circulating hydrogen supply lines of existing fuel cells can not solve the above problems effectively.

The Chinese patent application with publication number CN116190709A discloses a fuel cell hydrogen supply cycle system, which adopts a series connection of an injector and a hydrogen circulation pump. This system not only improves the recovery and utilization rate of excess hydrogen in the fuel cell reaction stack, but also humidifies the hydrogen entering the reaction stack. The hydrogen circulation pump also incorporates a hydraulic resistance reduction design, which makes low flow resistance and high reflux ratio, thereby reducing the ice breaking risk during fuel cell start-up. However, the series connection of the hydrogen circulation pump and injector is relatively simple, which does not fully utilize the full role of the hydrogen circulation pump in the hydrogen supply cycle and cannot effectively solve problems such as hydrogen starvation.

### SUMMARY

Based on the above technical problems, the present invention provides a fuel cell hydrogen gas circuit device and a control method thereof.

The technical solution adopted by the present invention is:

A fuel cell hydrogen gas circuit device, including a hydrogen cylinder, a hydrogen pressure stabilizing chamber, an injector, a hydrogen-water separator, and a hydrogen circulation pump; the hydrogen cylinder is connected to the hydrogen pressure stabilizing chamber through a first delivery pipeline, the hydrogen pressure stabilizing chamber is connected to a first inlet of the injector through a second delivery pipeline, and an outlet of the injector is connected to an inlet of the fuel cell stack through a third delivery pipeline.

An outlet of the fuel cell stack is connected to the hydrogen-water separator through a fourth delivery pipeline, a gas outlet of the hydrogen-water separator is connected to a second inlet of the injector through a fifth delivery pipeline, the fifth delivery pipeline is connected to an inlet of the hydrogen circulation pump, an outlet of the hydrogen circulation pump is connected to the fifth delivery pipeline through a sixth delivery pipeline, and the sixth delivery pipeline is connected to the inlet of the fuel cell stack through branch pipelines.

The outlet of the hydrogen circulation pump is connected to the outlet of the fuel cell stack through a seventh delivery pipeline.

The fifth delivery pipeline is connected to a hydrogen exhaust pipeline.

A first control valve and a fifth control valve are provided on the sixth delivery pipeline, the connection points of the branch pipelines and the sixth delivery pipeline are between the first control valve and the fifth control valve, a second control valve is provided on the seventh delivery pipeline, a third control valve is provided on the first delivery pipeline, and a fourth control valve is provided on the hydrogen exhaust pipeline.

Preferably, the fuel cell stack includes three single cells, three injectors are provided correspondingly, and each injector is connected to each single cell.

There are three branch pipelines, including a first branch pipeline, a second branch pipeline, and a third branch pipeline; a sixth control valve is provided on the first branch pipeline, a seventh control valve is provided on the second branch pipeline, and an eighth control valve is provided on the third branch pipeline.

The first branch pipeline, the second branch pipeline, and the third branch pipeline are connected to the inlets of the three single cells correspondingly.

Preferably, the third control valve is a pressure reducing valve, the fourth control valve is a hydrogen discharge solenoid valve, and the first control valve, the second control valve, the fifth control valve, the sixth control valve, the seventh control valve, and the eighth control valve are all globe valves.

A control method for the fuel cell hydrogen gas circuit device descended above, including the following steps:
(1) delivering hydrogen stored in the hydrogen cylinder through the first delivery pipeline to the hydrogen pressure stabilizing chamber, and reducing an inlet pressure to a required outlet pressure when passing through the third control valve;
(2) after stabilizing the pressure through the hydrogen pressure stabilizing chamber, delivering the hydrogen gas to the injector through the second delivery pipeline, and then delivering to the inlet of the fuel cell stack through the third delivery pipeline;
(3) the hydrogen undergoes a chemical reaction in the fuel cell stack, discharging gas after the chemical reaction from the outlet of the fuel cell stack, delivering to the hydrogen-water separator through the fourth delivery pipeline, then delivering the hydrogen separated by the hydrogen-water separator to the injector through the fifth delivery pipeline and converging with the hydrogen transported from the first delivery pipeline, and then supplying to the fuel cell stack;
(4) conducting circulating hydrogen supply when the fourth control valve is closed, and conducting hydrogen discharge when the fourth control valve is opened;
(5) during circulating hydrogen supply, the hydrogen also enters the hydrogen circulation pump through the fifth delivery pipeline; after the hydrogen reaches the hydrogen circulation pump, then supplying the hydrogen at the inlet of the fuel cell stack, at the outlet of the fuel cell stack, or simultaneously at the inlet and the outlet of the fuel cell stack through the sixth delivery pipeline, the seventh delivery pipeline, and switching of the first control valve, the second control valve, the fifth control valve, the sixth control valve, the seventh control valve, and the eighth control valve.

The control method for the fuel cell hydrogen circuit device descended above:

A, using a parallel connection of the injector and the hydrogen circulation pump when the fuel cell stack operates at low power, and control steps are as follows:
Opening the first control valve, the third control valve, the sixth control valve, the seventh control valve, and the eighth control valve, and closing the second control valve, the fourth control valve, and the fifth control valve;
Delivering the hydrogen in the hydrogen cylinder to the injector, and then the hydrogen reaches the inlet of the fuel cell stack, delivering the hydrogen required for reaction to the fuel cell stack; due to high pressure and fast gas flow rate of the hydrogen, a large amount of hydrogen has been discharged from the outlet of the fuel cell stack without reaction and processed through the hydrogen-water separator;
Part of the hydrogen separated by the hydrogen-water separator returns to the inlet of the injector, and is then supplied to the fuel cell stack through the injector; the other part of the hydrogen flows to the hydrogen circulation pump, and the hydrogen is delivered to the outlet of the injector through the hydrogen circulation pump, directly supplying the hydrogen to the fuel cell stack from the inlet without passing through the injector;
B, using a series connection of the injector and the hydrogen circulation pump when the fuel cell stack operates at medium to high power, and control steps are as follows:

Opening the first control valve, the third control valve, and the fifth control valve, and closing the second control valve, the fourth control valve, the sixth control valve, the seventh control valve, and the eighth control valve;
Delivering the hydrogen in the hydrogen cylinder to the injector, then the hydrogen reaches the inlet of the fuel cell stack, delivering the hydrogen required for the reaction to the fuel cell stack, and the hydrogen discharged from the fuel cell stack is process through the hydrogen-water separator;
Part of the hydrogen separated by the hydrogen-water separator returns to the inlet of the injector, the other part of the hydrogen flows to the hydrogen circulation pump, and the hydrogen is delivered to the inlet of the injector through the hydrogen circulation pump and supplied to the fuel cell stack through the injector;
The switching between the parallel connection and the series connection of the injector and the hydrogen circulation pump follows the following steps:

Connecting the fuel cell stack to a sensor module, and connecting the sensor module to a fuel cell controller; the sensor module collects signals from the fuel cell stack and transmits the signals to the fuel cell controller through communication, and the fuel cell controller determines whether the fuel cell stack operates at the low power or the medium to high power; when an output power of the fuel cell stack is w₁ and a peak power is w₂, and when 0<w₁<40% w₂, the fuel cell stack operates at the low power; when w₁>40% w₂, the fuel cell stack operates the medium to high power; for the low power, choosing the parallel connection of the injector and the hydrogen circulation pump, and for the medium to high power, choosing the series connection of the injector and the hydrogen circulation pump.

The speed regulation of the hydrogen circulation pump described above adopts following steps:
a. using the series connection of the injector and the hydrogen circulation pump and the parallel connection of the injector and the hydrogen circulation pump, operating the hydrogen circulation pump at different speeds in a laboratory under different operating conditions, including starting, stopping, loading, and unloading, so as to measure a parasitic power and a vibration noise;
b. selecting hydrogen circulation pump speed with a minimum parasitic power and a minimum vibration noise in each operating condition, and recording a vehicle specific power, a volume specific power, a mass specific power, and an operating power at the corresponding hydrogen circulation pump speed; determining an output layer of a neural network algorithm as the hydrogen circulation pump speed, and an input layer as the vehicle specific power, the volume specific power, the mass specific power, and the operating power at the corresponding hydrogen circulation pump speed, thereby obtaining the trained data-driven model;
c. collecting signals from the fuel cell stack by the sensor module, transmitting the signals to the trained data-driven model through communication, and outputting a speed value of the hydrogen circulation pump based on the signals from the fuel cell stack by the trained data-driven model;
the signal of the fuel cell stack includes parameters of current, voltage, the vehicle specific power, the volume specific power, and the mass specific power;
d. according to the speed value of the hydrogen circulation pump obtained in step c, controlling a motor of the hydrogen circulation pump to reduce or increase the hydrogen circulation pump speed.

The advantageous technical effects of the present invention are as following:

The present invention achieves the series-parallel switching of the injector and the hydrogen circulation pump as needed through the connection arrangement of the hydrogen delivery pipelines, the switching of various control valves, and the coordination of the hydrogen circulation pump and the injector. It can also supply hydrogen separately or simultaneously at the inlet and outlet of the fuel cell stack, thereby improving the efficiency of hydrogen circulation, relieving the working pressure of the injector, shortening the hydrogen transmission path, and reducing pressure loss. It can also effectively alleviate hydrogen starvation under loading conditions, water flooding, and platinum degradation.

Specifically, the present invention reduces the impact of gas flow on the injector by installing a hydrogen circulation pump. By directly supplying hydrogen to the outlet of the injector through the hydrogen circulation pump, the service life of the injector can be extended. Two branches supplying hydrogen to the inlet can improve the efficiency of circulating hydrogen supply and make the device more stable.

The hydrogen circulation pump can also complete the task of supplying hydrogen to the outlet of the fuel cell stack, which can cope with the hydrogen starvation phenomenon during loading conditions. Compared with using hydrogen gas from a hydrogen cylinder to directly supply hydrogen to the outlet, it is more fuel-efficient, while reducing the difficulty of controlling the fuel cell. By using a more gentle hydrogen gas circulation pump to supply hydrogen at the outlet, the goal of the inlet-outlet dual channel hydrogen supply can be achieved.

By supplying hydrogen through a separate outlet, water flooding can be effectively alleviated, suitable for vehicles. The method of supplying hydrogen through a short-term separate outlet of hydrogen inside the device effectively saves fuel while ensuring the continuation of the reaction. The problem of uneven water distribution on the proton exchange membrane is alleviated through gas purging. When severe water flooding occurs, excess water can also be discharged from the fuel cell stack by supplying hydrogen separately to the inlet without using gas cylinders, while saving fuel.

By not using hydrogen gas cylinders, the inherent hydrogen gas inside the device is used for dual channel hydrogen supply after the vehicle is stopped, achieving the recovery of platinum degradation performance of the catalyst. At the same time, the catalyst can be placed in a relatively uniform hydrogen environment, restoring the reversible platinum degradation reaction process and increasing the platinum content on the catalyst carbon carrier. Compared with the existing solution of directly using hydrogen gas cylinders to blow the fuel cell with hydrogen gas, it is more fuel-efficient and suitable for on-board use.

By using a flexible control method that switches between series-parallel schemes of the hydrogen circulation pump and the injector, covering full power hydrogen circulation, fully utilizing the advantages of both hydrogen circulation pump and injector, and finding the most suitable speed of the hydrogen circulation pump through neural network algorithms, so as to adapt to different series-parallel schemes and speed requirements under different working conditions, the vibration noise and parasitic power of the device can reach the ideal situation.

### BRIEF DESCRIPTION OF THE DRAWINGS

FIG. 1 is a schematic diagram of the structural principle of one embodiment of the fuel cell hydrogen gas circuit device of the present invention;

FIG. 2 is a schematic diagram of the parallel connection of a injector and a hydrogen circulation pump in the present invention, wherein the dashed line in the figure shows the direction of the circulating hydrogen gas, and the same applies below;

FIG. 3 is a schematic diagram of the series connection of the injector and the hydrogen circulation pump in the present invention;

FIG. 4 is a schematic diagram of the selection of the circulating hydrogen supply pipeline and the control flow of the hydrogen circulation pump in the hydrogen gas circuit control method of the fuel cell of the present invention;

FIG. 5 is a schematic diagram of an optimal speed prediction model for the hydrogen circulation pump based on neural network algorithm in the present invention;

FIG. 6 is a schematic diagram of a BP-PID algorithm model directly controlling the speed of the hydrogen circulation pump in the present invention;

FIG. 7 is a schematic diagram of an inlet-outlet dual channel hydrogen supply for dealing with hydrogen starvation phenomenon under loading conditions in the present invention;

FIG. 8 is a flow chart of the inlet-outlet dual circulation channel hydrogen supply for dealing with hydrogen starvation phenomenon under loading conditions in the present invention;

FIG. 9 is a schematic diagram of an outlet circulation hydrogen supply for dealing with uneven water distribution on the proton exchange membrane in the present invention;

FIG. 10 is a flow chart of the outlet circulation hydrogen supply for dealing with uneven water distribution on the proton exchange membrane in the present invention;

FIG. 11 is a schematic diagram of an inlet circulation hydrogen supply for dealing with water flooding in the present invention;

FIG. 12 is a schematic diagram of the inlet-outlet dual channel circulation hydrogen supply for increasing the platinum content of the catalyst in the present invention;

FIG. 13 is a schematic diagram of hydrogen discharging after the completion of all reactions in the present invention.

Reference numbers in the drawings: 1-hydrogen cylinder, 2-hydrogen pressure stabilizing chamber, 3-injector, 4-hydrogen-water separator, 5-hydrogen circulation pump, 6-second delivery pipeline, 7-third delivery pipeline, 8-fuel cell stack, 9-fourth delivery pipeline, 10-fifth delivery pipeline, 11-sixth delivery pipeline, 12-seventh delivery pipeline, 13-first control valve, 14-second control valve, 15-third control valve, 16-fourth control valve, 17-fifth control valve, 18-sixth control valve, 19-seventh control valve, 20-eighth control valve, 21-sensor module, 22-first delivery pipeline, 23-branch pipeline, 24-hydrogen exhaust pipeline.

### DETAILED DESCRIPTION OF THE EMBODIMENTS

In order to make the technical problems, technical solutions and beneficial effects of the present invention clearer, the present invention will be further described in detail below with reference to the accompanying drawings and embodiments.

In order to address potential faults in the loading and unloading conditions of fuel cell vehicles, multi-branch design is carried out to reduce additional equipment such as hydrogen circulation devices and auxiliary tanks. During the circulation process, hydrogen in the hydrogen cylinder is not used to increase the vehicle range, reduce the load pressure on the injector, extend the service life of the injector, and eliminate the passive circulation of the injector to increase active control capability. It provides the series connection of the circulation pump and the injector, and the role of the hydrogen circulation pump in the circulation process is fully utilized.

Therefore, the present invention divides the unused hydrogen into two paths through a hydrogen circulation pump and supplies the hydrogen to the inlet and the outlet of the fuel cell stack. By supplying the hydrogen to the inlet of the fuel cell stack, it increases the utilization rate of hydrogen; By supplying the hydrogen to the outlet of the fuel cell stack, the unreacted hydrogen is supplied to the outlet of the fuel cell stack through a hydrogen circulation pump to address hydrogen starvation caused by insufficient hydrogen consumption during loading conditions, and the hydrogen from the hydrogen cylinder is not used to ensure low-speed controllability of the hydrogen gas flow in the circulation pump. Due to the high hydrogen flow rate at the inlet, the proton exchange membrane drying often occurs at the inlet while water accumulates and floods at the outlet. Therefore, inlet-outlet bidirectional hydrogen supply ensures even distribution of water on the proton exchange membrane. The excess water is blown to the water deficient position on the proton exchange membrane by the purging effect of the gas flow rate at the outlet to alleviate water flooding. At the same time, a protective measure is applied after shutdown to increase the performance gain of the platinum catalyst in the hydrogen environment, thereby increasing the platinum content of the catalyst and improving catalytic efficiency and fuel cell engine performance.

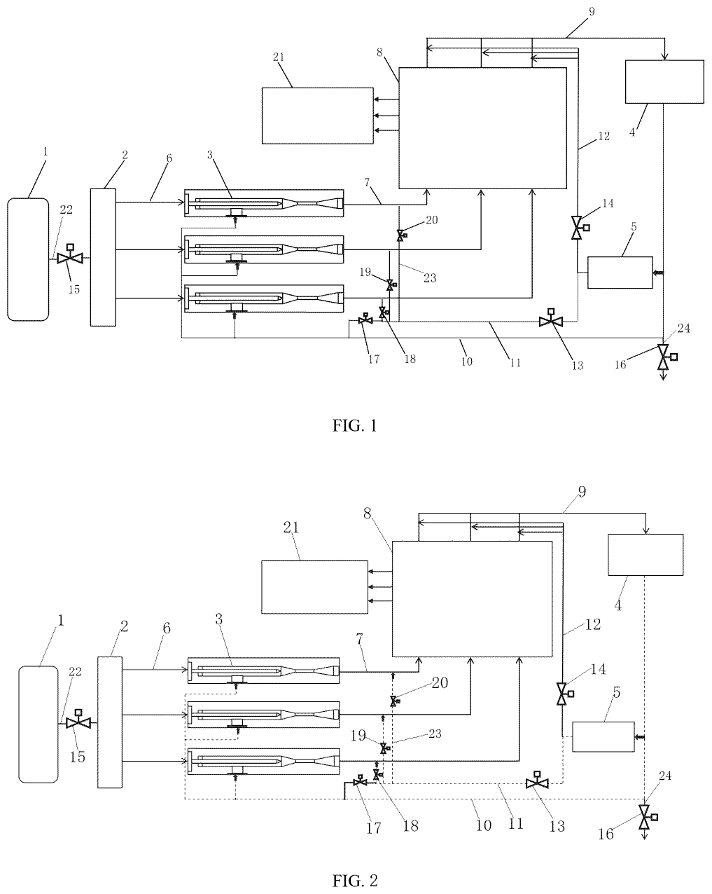

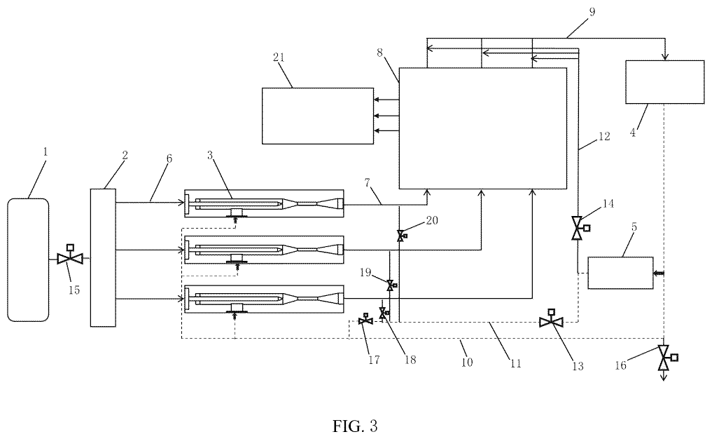

As shown in FIG. 1, a fuel cell hydrogen gas circuit device is provided, which includes a hydrogen cylinder 1, a hydrogen pressure stabilizing chamber 2, an injector 3, a hydrogen-water separator 4, and a hydrogen circulation pump 5. The hydrogen cylinder 1 is connected to the hydrogen pressure stabilizing chamber 2 through a first delivery pipeline 22, the hydrogen pressure stabilizing chamber 2 is connected to a first inlet of the injector 3 through a second delivery pipeline 6, and an outlet of the injector 3 is connected to an inlet of the fuel cell stack 8 through a third delivery pipeline 7. An outlet of the fuel cell stack 8 is connected to the hydrogen-water separator 4 through a fourth delivery pipeline 9, and a gas outlet of the hydrogen-water separator 4 is connected to a second inlet of the injector 3 through a fifth delivery pipeline 10. The fifth delivery pipeline 10 is connected to an inlet of the hydrogen circulation pump 5, an outlet of the hydrogen circulation pump 5 is connected to the fifth delivery pipeline 10 through a sixth delivery pipeline 11, and the sixth delivery pipeline 11 is connected to the inlet of the fuel cell stack 8 through branch pipelines 23. The outlet of the hydrogen circulation pump 5 is connected to the outlet of the fuel cell stack 8 through a seventh delivery pipeline 12. The fifth delivery pipeline 10 is connected to a hydrogen exhaust pipeline 24. A first control valve 13 and a fifth control valve 17 are provided on the sixth delivery pipeline 11, the connection points of the branch pipelines 23 and the sixth delivery pipeline 11 are between the first control valve 13 and the fifth control valve 17. A second control valve 12 is provided on the seventh delivery pipeline 14, a third control valve 15 is provided on the first delivery pipeline 22, and a fourth control valve 16 is provided on the hydrogen exhaust pipeline 24.

The fuel cell stack 8 includes three single cells, three injectors 3 are provided correspondingly, and each injector is connected to one single cell. There are three branch pipelines, including a first branch pipeline, a second branch pipeline, and a third branch pipeline. A sixth control valve 18 is provided on the first branch pipeline, a seventh control valve 19 is provided on the second branch pipeline, and an eighth control valve 20 is provided on the third branch pipeline. The first branch pipeline, the second branch pipeline, and the third branch pipeline are connected to the inlets of the three single cells correspondingly.

The third control valve 15 is a pressure reducing valve, the fourth control valve 16 is a hydrogen discharge solenoid valve, and the first control valve 13, the second control valve 14, the fifth control valve 17, the sixth control valve 18, the seventh control valve 19, and the eighth control valve 20 are all globe valves.

The hydrogen cylinder 1 stores the hydrogen required for fuel cells, which is high-pressure gas and cannot directly enter the fuel cell flow channel, otherwise it will cause huge impact on the membrane electrode. The high-pressure hydrogen gas passes through the pressure reducing valve, namely the third control valve 15, then reaches the hydrogen pressure stabilizing chamber 2. The pressure reducing valve is a valve that adjusts the inlet pressure to a certain required outlet pressure and relies on the energy of the medium itself to automatically maintain stable outlet pressure. The appropriate volume of the pressure stabilizing chamber can not only improve the hydrogen supply efficiency by taking advantage of the fluctuation effect, but also make the pressure environment in the pressure stabilizing chamber relatively stable, providing good conditions for utilizing dynamic effect. Then, the hydrogen gas passes through the injector 3, which can suck out and reflux the hydrogen gas in the fuel cell stack, and resupply the hydrogen to the fuel cell stack 8 after converging with the supplied hydrogen gas, so as to ensure sufficient gas flow, achieving high anode stoichiometric ratio and anti-water flooding effect. The injector is a device that extracts gas from a target container or system, its effect is similar to that of a compressor or vacuum pump, and its biggest difference from the two is that the injector has no moving parts. Therefore, the injector is a relatively low-cost, easy to operate, and easy to maintain device. Eventually, hydrogen enters the interior of the fuel cell stack to participate in chemical reactions.

Due to the high flow rate of hydrogen, a portion of the hydrogen has not been fully consumed. Therefore, hydrogen is discharged from the outlet of the fuel cell stack and passes through the hydrogen-water separator 4. It is started to hydrogen circulation when the fourth control valve 16 is closed, and when the fourth control valve 16 is opened, hydrogen is directly discharged. The hydrogen-water separator, namely gas-liquid separator mainly utilizes the different specific gravity of the gas-liquid during the fluid turning process, causing the liquid to sink and separate from the gas. It can use baffles to turn the main fluid, or use centrifugal separation to throw the liquid onto the container wall through high-speed airflow, these liquids lose kinetic energy and achieve gas separation. Some use filtration or condenser to achieve gas-liquid separation. The design of different gas-liquid separation principles can be integrated into one gas-liquid separator. The fourth control valve 16 is a valve for hydrogen discharge, which is located in the hydrogen gas circuit of the fuel cell system. The unreacted hydrogen on the anode side and the nitrogen and water permeating from the cathode side will flow through the hydrogen-water separator, most of the liquid water is separated, and the remaining small amount of water and mixed gas are discharged into the atmosphere through the fourth control valve 16. When the fourth control valve 16 is opened, the small amount of water and mixed gas on the anode side are discharged into the atmosphere, so that the hydrogen concentration of the fuel cell stack reaction is high and the conversion efficiency is not reduced too much. When the fourth control valve is closed, the anode can maintain sufficient working pressure to maintain good conversion efficiency of the fuel cell stack. When the control valve is opened or closed, it is achieved by the up and down movement of the moving iron core. When the valve is powered on, under the action of the coil magnetic field, the stationary iron core will suck up the moving iron core, and the spring will be compressed. In this moment, the moving iron core and the stationary iron core are attracted, and the moving iron core and the valve seat are separated, so that fluid can flow from the inlet to the outlet. When the valve is powered off, the magnetic field of the coil disappears, the moving iron core and the stationary iron core are separated, under the action of spring recovery and the weight of the moving iron core, the moving iron core is pressed against the valve seat, thereby cutting off the fluid flow from the inlet to the outlet.

When hydrogen reaches the hydrogen circulation pump, it can be supplied through two circuits, after relevant judgment, it is determined whether to supply hydrogen from the inlet or the outlet of the fuel cell stack, or to supply hydrogen from both the inlet and the outlet of the fuel cell stack. The working principle of the hydrogen circulation pump 5 is mainly divided into suction and compression. In the suction stage, hydrogen enters the pump chamber through the pump body and is then sucked in by the impeller. In the compression stage, the impeller begins to rotate, compressing and pushing hydrogen to the next process step. Throughout the process, the hydrogen circulation pump 5 needs to maintain a stable working state to ensure that the flow rate and pressure of hydrogen meet the process requirements. Then, different functions are executed through the opening and closing switching of the first control valve 13 and the second control valve 14.

Specifically, a control method for the fuel cell hydrogen gas circuit device is provided by the present invention, which includes the following steps:

(1) Delivering hydrogen stored in the hydrogen cylinder 1 through the first delivery pipeline 22 to the hydrogen pressure stabilizing chamber 2, and reducing an inlet pressure to a required outlet pressure when passing through the third control valve 15.

(2) After stabilizing the pressure through the hydrogen pressure stabilizing chamber 2, delivering the hydrogen gas to the injector 3 through the second delivery pipeline 6, and then delivering to the first inlet of the fuel cell stack 8 through the third delivery pipeline 7.

(3) The hydrogen undergoes a chemical reaction in the fuel cell stack 8, discharging gas after the chemical reaction from the outlet of the fuel cell stack 8, delivering to the hydrogen-water separator 4 through the fourth delivery pipeline 9, then delivering the hydrogen separated by the hydrogen-water separator 4 to the second inlet of the injector through the fifth delivery pipeline 10 and converging with the hydrogen transported from the first delivery pipeline 22, and then supplying to the fuel cell stack 8.

(4) Conducting circulating hydrogen supply when the fourth control valve 16 is closed, and conducting hydrogen discharge when the fourth control valve 16 is opened.

(5) During circulating hydrogen supply, the hydrogen also enters the hydrogen circulation pump 5 through the fifth delivery pipeline 10; after the hydrogen reaches the hydrogen circulation pump 5, then supplying the hydrogen at the inlet of the fuel cell stack 8, at the outlet of the fuel cell stack 8, or simultaneously at the inlet and the outlet of the fuel cell stack 8 through the sixth delivery pipeline 11, the seventh delivery pipeline 12, and switching of the first control valve 13, the second control valve 14, the fifth control valve 17, the sixth control valve 18, the seventh control valve 19, and the eighth control valve 20.

Further:

A. using a parallel connection of the injector 3 and the hydrogen circulation pump 5 when the fuel cell stack 8 operates at low power, and the control steps are as follows:

The first control valve 13, the third control valve 15, the sixth control valve 18, the seventh control valve 19, and the eighth control valve 20 are opened, and the second control valve 14, the fourth control valve 16 (the fourth control valve is always closed during normal operation), and the fifth control valve 17 are closed.

The hydrogen in the hydrogen cylinder 1 is delivered to the injector 3, and then the hydrogen reaches the inlet of the fuel cell stack 8, delivering the hydrogen required for reaction to the fuel cell stack 8. Due to high pressure and fast gas flow rate of the hydrogen, a large amount of hydrogen has been discharged from the outlet of the fuel cell stack without reaction and processed through the hydrogen-water separator 4.

Part of the hydrogen separated by the hydrogen-water separator 4 returns to the second inlet of the injector, and is then supplied to the fuel cell stack through the injector 3. The other part of the hydrogen flows to the hydrogen circulation pump 5, and the hydrogen is delivered to the outlet of the injector 3 through the hydrogen circulation pump 5, directly supplying the hydrogen to the fuel cell stack 8 from the inlet without passing through the injector 3.

This control scheme is suitable for the condition that the fuel cell stack the operates at lower power. It is a parallel solution of the injector 3 and the hydrogen circulation pump 5, which divides the hydrogen that needs to be circulated and increases the pressure of the circulating hydrogen inside the system to varying degrees. When the fuel cell stack operates at lower power, it mainly relies on the hydrogen circulation pump for hydrogen circulation, as shown in FIG. 2. The hydrogen in hydrogen cylinder 1 is transported to the inlet of the injector and then reaches the inlet of the fuel cell stack, delivering the required hydrogen gas for the reaction to the fuel cell stack composed of three single fuel cells. Due to the high hydrogen pressure and fast gas flow rate, a large amount of hydrogen gas has been discharged from the outlet without reaction. At this time, the hydrogen is dried through the hydrogen-water separator to collect hydrogen that can be recycled again. Part of the hydrogen from hydrogen-water separator 4 returns to the inlet of the injector and is then supplied to the fuel cell stack through the injector. The other part of the hydrogen flows to the hydrogen circulation pump. At this time, due to the closing of the second control valve, the hydrogen can only flow along the pipeline of the first control valve. Therefore, the hydrogen is transported to the outlet of the injector through the hydrogen circulation pump, and is directly supplied to the fuel cell stack from the inlet through the pipeline without passing through the injector. The biggest innovation point of this method is to add a hydrogen circulation pump to directly supply hydrogen to the outlet of the injector on the basis of simply using the injector circulation, so as to relieve the working pressure of the injector, and further improve the efficiency of hydrogen circulation through the circulation pump. The pressure loss is reduced through shortening the hydrogen transmission path, and at the same time, the integrated design of fuel cells is used to reduce the cost of using high sealing pipelines. The existence of the hydrogen circulation pump shares a part of the hydrogen circulation pressure, compared with a single circulation branch, it reduces pipeline pressure and thus slows down gas impact and vibration on related valve components.

B. using a series connection of the injector 3 and the hydrogen circulation pump 5 when the fuel cell stack operates at medium to high power, and the control steps are as follows:

The first control valve 13, the third control valve 15, and the fifth control valve 17 are opened, and the second control valve 14, the fourth control valve 16, the sixth control valve 18, the seventh control valve 19, and the eighth control valve 20 are closed. The hydrogen in the hydrogen cylinder 1 is delivered to the injector 3, then the hydrogen reaches the inlet of the fuel cell stack 8, delivering the hydrogen required for the reaction to the fuel cell stack 8, and the hydrogen discharged from the fuel cell stack is process through the hydrogen-water separator 4. The part of the hydrogen separated by the hydrogen-water separator 4 returns to the inlet of the injector 3, the other part of the hydrogen flows to the hydrogen circulation pump 5, and the hydrogen is delivered to the inlet of the injector 3 through the hydrogen circulation pump 5 and supplied to the fuel cell stack through the injector 3.

This control scheme is suitable for the operation of the fuel cell stack at medium to high power. It is a series connection scheme of the injector and the hydrogen circulation pump, with the hydrogen circulation pump 5 and the injector 3 jointly responsible for circulating hydrogen pressure boosting.

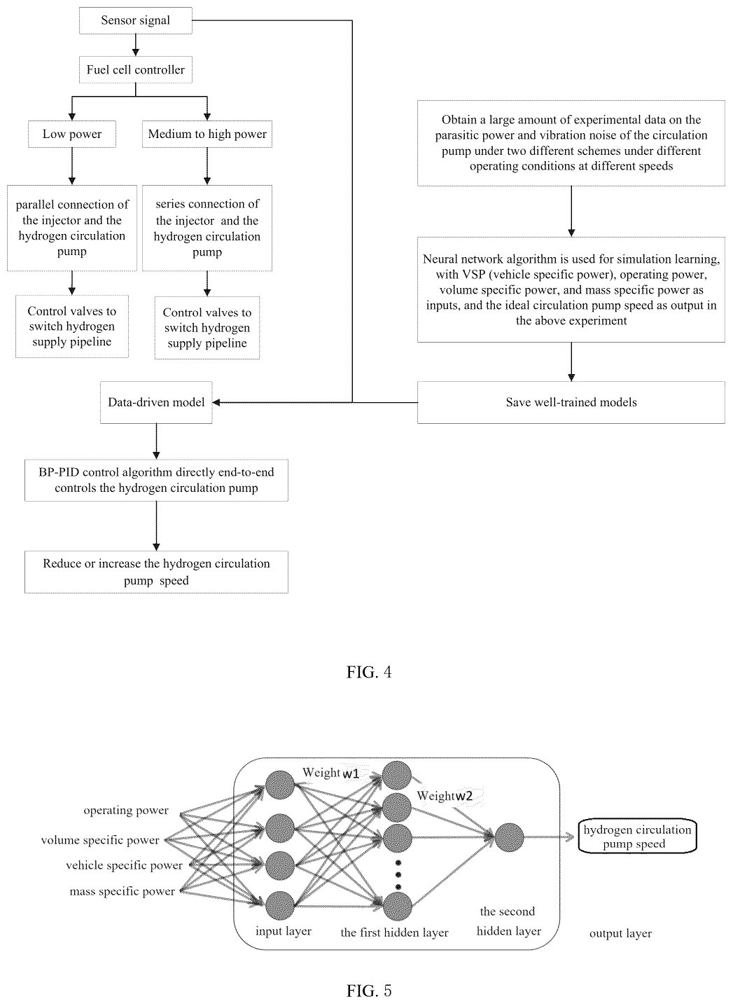

Furthermore, as shown in FIG. 4, the switching between the parallel connection and the series connection of the injector 3 and the hydrogen circulation pump 5 follows the following steps:

The fuel cell stack 8 is connected to a sensor module 21, and the sensor module is connected to a fuel cell controller. The sensor module collects signals such as current and signals from the fuel cell stack, and transmits the signals to the fuel cell controller through CAN communication, and the fuel cell controller determines whether the fuel cell stack operates at the low power or the medium to high power. When the output power of the fuel cell stack is w₁ and a peak power is w₂, and 0<w₁<40% w₂, the fuel cell stack operates at the low power. When w₁>40% w₂, the fuel cell stack operates the medium to high power. For the low power, the parallel connection of the injector 3 and the hydrogen circulation pump 5 is selected, and for the medium to high power, the series connection of the injector and the hydrogen circulation pump is selected.

As shown in FIG. 4-FIG. 6, the control method for the fuel cell hydrogen circuit device according to claim 4, wherein the speed regulation of the hydrogen circulation pump adopts following steps:
a. Using the series connection of the injector and the hydrogen circulation pump, and the parallel connection of the injector and the hydrogen circulation pump, operating the hydrogen circulation pump at different speeds in a laboratory under different operating conditions, including starting, stopping, loading, and unloading, so as to measure a parasitic power and a vibration noise.
b. Selecting hydrogen circulation pump speed with the minimum parasitic power and the minimum vibration noise in each operating condition, and recording a vehicle specific power (VSP), a volume specific power, a mass specific power, and an operating power at the corresponding hydrogen circulation pump speed; determining the output layer of a neural network algorithm as the hydrogen circulation pump speed, and the input layer as the vehicle specific power, the volume specific power, the mass specific power, and the operating power at the corresponding hydrogen circulation pump speed, thereby obtaining the trained data-driven model.
c. Collecting signals from the fuel cell stack by the sensor module, transmitting the signals to the trained data-driven model through CAN communication, and outputting the speed value of the hydrogen circulation pump based on the signals from the fuel cell stack by the trained data-driven model.

The signal of the fuel cell stack includes parameters of current, voltage, the vehicle specific power, the volume specific power, and the mass specific power.

d. According to the speed value of the hydrogen circulation pump obtained in step c, controlling a permanent magnet synchronous motor of the hydrogen circulation pump through BP-PID control algorithm to reduce or increase the hydrogen circulation pump speed.

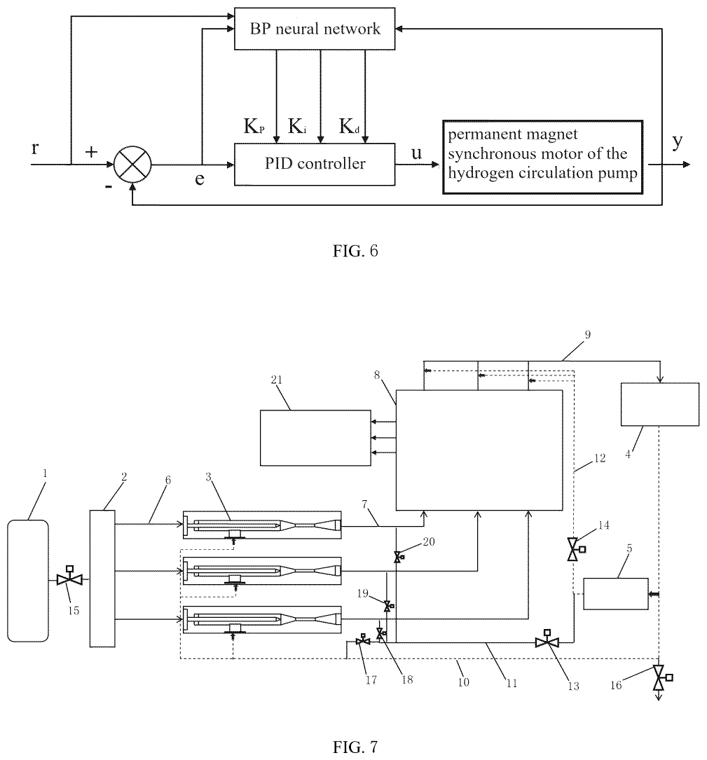

In the above steps, the BP-PID control algorithm is used to directly control the permanent magnet synchronous motor to reduce or increase the speed of the hydrogen circulation pump. The BP neural network is used to achieve good mapping ability of the nonlinear function, and the PID proportional, integral and derivative parameters are combined nonlinearly to obtain the optimal solution as shown in FIG. 6. The BP neural network outputs PID parameters, and PID adopts incremental expression:

$$u ( k ) = u ( k - 1 ) + {K}_{P} [ e ( k ) - e ( k - 1 ) ] + {K}_{I} e ( k ) + {K}_{D} [ e ( k ) - 2 e ( k - 1 ) + e ( k - 2 ) ]$$

In the formula, Kp, Ki, and Kd are coefficients of proportional, integral, and derivative, respectively; e (k) is the difference between the expected output and the actual output at the current sampling time; u (k) is the actual output quantity, i.e. the duty cycle, used to control the motor speed; u (k-1) is the previous output duty cycle, e (k-1) is the error value between the target output for the previous time and the actual output duty cycle; e (k) is the error value between the target output for this time and the actual output duty cycle; and e (k-2) is the error value between the target output for the time before previous time and the actual output duty cycle.

The input of BP neural network input layer:

$${O}_{j}^{( 1 )} = x ( j ) ( j = 1 , 2 , 3 , … , m )$$

The input of hidden layer:

$$n e {t}_{i}^{2} ( k ) = {\sum }_{j = 0}^{m} {w}_{i j}^{2} {O}_{j}^{1}$$

The output of the hidden layer:

$${O}_{j}^{2} ( k ) = f ( {net}_{i}^{2} ( k ) )$$

The input of output layer:

$$n e {t}_{l}^{3} ( k ) = {\sum }_{l = 0}^{n} {w}_{k i}^{3} {O}_{l}^{2}$$

The output of the output layer:

$${O}_{l}^{3} ( k ) = g ( n e {t}_{l}^{3} ( k ) )$$

In the formula, x (j) represents the input layer node, wᵢⱼ² represents the weights from the input layer to the hidden layer; Wₖᵢ³ represents the weights from the hidden layer to the input layer; Oⱼ⁽¹⁾ represents the input of the input layer; netᵢ²(k) represents the input of the hidden layer; Oⱼ²(k) represents the output of the hidden layer; netᵢ³(k) represents the input of the output layer; Oᵢ³(k) represents the output of the output layer; and g and f represent the functions of the hidden layer data processing process.

The motor control algorithm based on BP-PID is:

Step 1: Determine the neural network structure, determine the number of nodes in the input layer and the hidden layer, select the initial values of the weighting coefficients wᵢⱼ²(0) and Wₖᵢ³(0) for each layer, choose the learning rate and inertia coefficient, where k=1.

Step 2: Sample the given and feedback signals and calculate the error e(k)=r(k)−y(k).

Step 3: Determine the input quantity.

Step 4: According to the above formula, calculate the input and the output of each layer of neurons. The output layer of the neural network is the three adjustable parameters Kp, Ki and Kd of the PID controller.

Step 5: Calculate the control output u(k) of the PID controller using the incremental PID control formula.

Step 6: Perform neural network learning to automatically adjust the weighting coefficients of the output layer and the hidden layer in real-time, achieving adaptive adjustment of PID control parameters.

Step 7: Let k=k+1, and return to step 2.

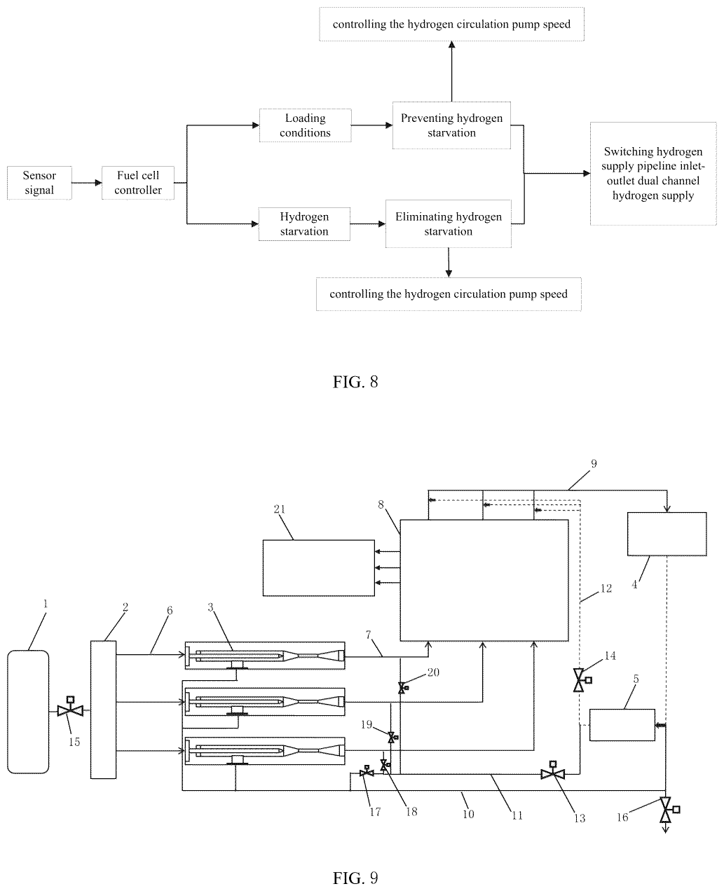

The control method for the fuel cell hydrogen gas circuit device in the present invention, it can alleviates a phenomenon of hydrogen starvation under loading conditions through circulating hydrogen to the outlet of the fuel cell stack, as shown in FIG. 7-FIG. 8, and the control steps are as follows:

When a fuel cell vehicle is in the loading condition, the phenomenon of hydrogen starvation are caused by insufficient or untimely hydrogen reaction due to a rapid rise of the load, so during the loading condition, opening the second control valve 14 and the third control valve 15, and closing the first control valve 13, the fourth control valve 16 (the fourth control valve is always closed in normal operation), the fifth control valve 17, the sixth control valve 18, the seventh control valve 19, and the eighth control valve 20, so that all the hydrogen flowing to the hydrogen circulation pump 5 is supplied to the outlet of the fuel cell stack 8, allowing the hydrogen in an internal flow channel of the fuel cell stack 8 to stay longer and react more fully to cope with the loading condition. In this functional usage condition, due to the instantaneous load increase, it is difficult to directly control the hydrogen in the hydrogen cylinder to increase the intake amount in a short time. However, using the hydrogen circulation pump 5 and the seventh delivery pipeline 12 to supply hydrogen to the outlet of the fuel cell can make it difficult for hydrogen to leave the fuel cell stack in a short time, increase the reaction time of hydrogen in the flow channel, and meet the demand for increased hydrogen gas during load increase, so that the chemical reaction is sufficient completed. The presence of the hydrogen circulation pump 5 and the seventh delivery pipeline 12 allows hydrogen supply to the outlet of the fuel cell stack without the need to extract hydrogen from the hydrogen cylinder that has not been consumed, but using the hydrogen circulation pump 5 for outlet hydrogen supply. At the same time, using the hydrogen circulation pump meets the hydrogen circulation requirements, so as to increase the resistance that the hydrogen leaves from the outlet of the fuel cell stack. Compared to the design without a hydrogen circulation pump, the pipeline design of this scheme makes the hydrogen circulation function more controllable to a certain extent, and increases the active control ability of the circulation through the hydrogen circulation pump. The hydrogen circulation pump supplies hydrogen to the outlet of the fuel cell stack, and at the same time, the hydrogen that can be used for circulation can maintain a certain flow rate, so that the two streams of gas leaving the fuel cell stack and gas entering the fuel cell stack from the circulating hydrogen can collide more strongly. The collided gas flow will make the hydrogen more evenly distributed inside the flow channel.

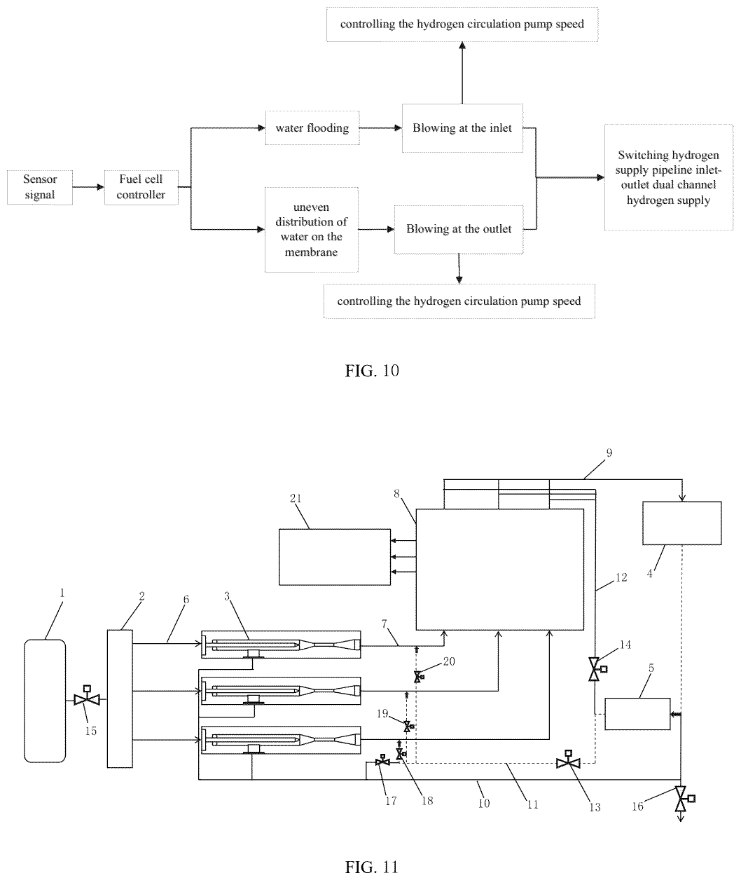

The control method for the fuel cell hydrogen gas circuit device of the present invention, it can also solve the uneven distribution of water on the proton exchange membrane and alleviate water flooding through circulating hydrogen supply, as shown in FIG. 9-FIG. 11, and the control steps are as follows:

When there is a shortage of water at the inlet of the fuel cell stack 8 and water accumulation at the outlet of the fuel cell stack 8 due to gas purging, resulting in local membrane dryness and local flooding inside a fuel cell, in a very short period of time, the first control valve 13, the third control valve 15, the fourth control valve 16, the fifth control valve 17, the sixth control valve 18, the seventh control valve 19, and the eighth control valve 20 are closed, and the second control valve 14 are opened. The closing of the third control valve 15 is aimed to stop the hydrogen supply of the hydrogen cylinder, so as to reduce a hydrogen flow rate at the inlet of the fuel cell stack. The way that uses the residual hydrogen in the system to supply hydrogen in a very short period of time increases hydrogen purging from the outlet to the inlet, at this moment, the hydrogen will only be supplied to the fuel cell stack from the outlet, while the hydrogen supply at the inlet has been stopped due to the closing of the third control valve 15. By utilizing reverse gas purging at the outlet of the fuel cell stack, the accumulated water at the outlet of the fuel cell stack can be supplemented to the upper portion of the proton exchange membrane lacks water at the inlet. Using the hydrogen circulation pump 5 makes the process more controllable. Adjusting the hydrogen circulation pump enables the outlet hydrogen supply to complete reverse gas purging in a short period of time. Due to the cessation of hydrogen supply at the inlet, the hydrogen entering from the outlet of the fuel cell stack is subject to less resistance.

When flooding is caused by a large amount of water accumulation generated by the reaction or by delayed drainage, the second control valve 14, the third control valve 15, the fourth control valve 16, and the fifth control valve 17 are closed, and the first control valve 13, the sixth control valve 18, the seventh control valve 19, and the eighth control valve 20 are opened. Firstly, the closing of the third control valve 15 is to stop the active hydrogen supply, reduce the supply amount of hydrogen gas, thereby reducing the reaction rate, and reducing the large amount of water generated due to chemical reactions, so as to control the reduction of water generation by slowing down the chemical rate. Using the gas purging effect to discharge the excess water inside the fuel cell stack. Specifically, the hydrogen circulation pump 5 is used to supply hydrogen separately to the inlet of the fuel cell stack, using the purging effect of circulating gas to solve the problem of excessive water flooding inside the fuel cell. Compared with directly using high-pressure hydrogen gas from the hydrogen cylinder 1 for purging, water generation is fundamentally reduced from the perspective of chemical reactions. Although high-pressure hydrogen gas has a fast flow rate and good purging effect, the influx of a large amount of hydrogen gas into the fuel cell stack not only increases the reaction rate, but also reduces the storage of hydrogen gas, which is a waste. Turning off the active supply of hydrogen may cause a certain degree of voltage drop, However, from the perspective of long-term use of the entire fuel cell, it not only alleviates flooding but also increases the service life of components such as membrane electrodes and catalysts.

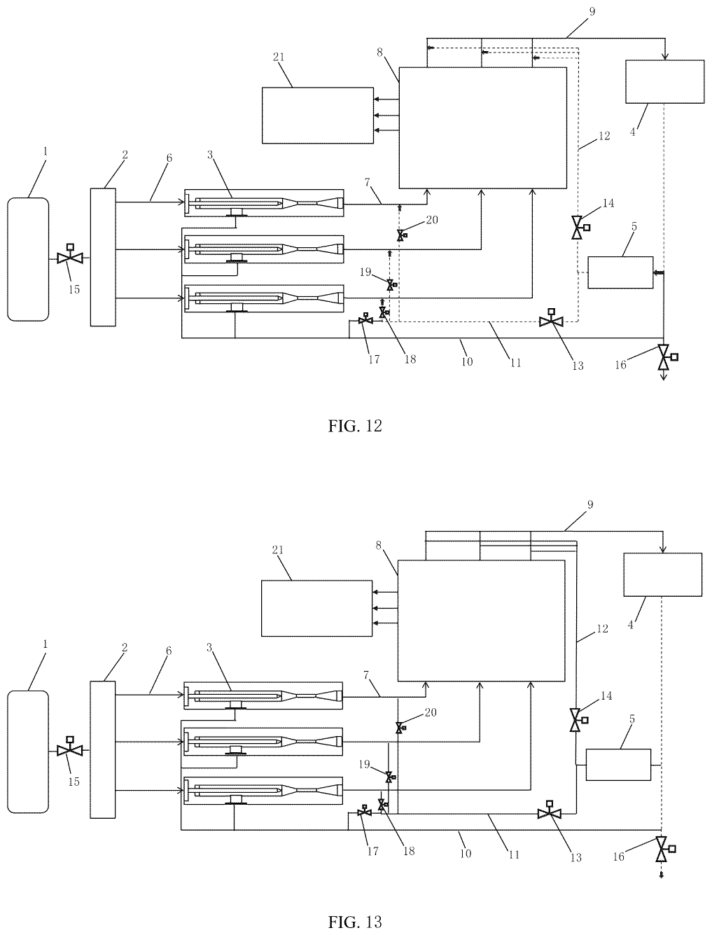

In the control method for the fuel cell hydrogen gas circuit device of the present invention, it can also uses the residual hydrogen inside the hydrogen gas circuit device to alleviate catalyst platinum poisoning and platinum degradation, as shown in FIG. 12, and the control steps are as follows:

When the platinum catalyst poisoning or the platinum degradation occurs, the third control valve 15, the fourth control valve 16, and the fifth control valve 17 are closed, and the first control valve 13, the second control valve 14, the sixth control valve 18, the seventh control valve 19, and the eighth control valve 20 are opened. It utilizes the hydrogen inside the hydrogen gas circuit device to supply hydrogen to the inlet and the outlet of the fuel cell stack, at the same time, stopping oxygen supply to a cathode side of the fuel cell, so that the fuel cell only supplies hydrogen, and the catalyst inside the fuel cell is in an uniform and sufficient hydrogen environment, in other word, in an environment of excessive saturated hydrogen gas, which can generate performance gains, restore the platinum degradation, reduce the performance degradation and improve reliability of the fuel cell stack. The advantage of this recovery operation is that it can fully charge the fuel cell stack with the remaining hydrogen gas inside the system every time the fuel cell engine stops working. This method can effectively increase the platinum content of the catalytic layer, timely reduce the intermediate products of platinum degradation in the reversible stage of platinum decomposition to platinum, and prevent platinum decomposition, platinum aggregation, and platinum detachment. This function in this scheme can perform internal circulation operation every time the vehicle is stopped, which is conducive to long-term platinum degradation, fully utilizing the residual hydrogen gas in the system after shutdown, extending the service life of the catalytic layer, continuously maintaining the existence of the active contact area (ESCA) on the surface of the catalytic layer, reducing the decay rate, and achieving the goal of improving the service life.

As shown in FIG. 13, after all reactions are completed, the first control valve 13, the second control valve 14, and the third control valve 15 are closed, and the fourth control valve 16 is opened to discharge hydrogen.

The part not mentioned in the above way can be realized by adopting or drawing lessons from the existing technology.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A fuel cell hydrogen gas circuit device, comprising a hydrogen cylinder, a hydrogen pressure stabilizing chamber, an injector, a hydrogen-water separator, and a hydrogen circulation pump; the hydrogen cylinder is connected to the hydrogen pressure stabilizing chamber through a first delivery pipeline, the hydrogen pressure stabilizing chamber is connected to a first inlet of the injector through a second delivery pipeline, and an outlet of the injector is connected to an inlet of the fuel cell stack through a third delivery pipeline;
an outlet of the fuel cell stack is connected to the hydrogen-water separator through a fourth delivery pipeline, a gas outlet of the hydrogen-water separator is connected to a second inlet of the injector through a fifth delivery pipeline, the fifth delivery pipeline is connected to an inlet of the hydrogen circulation pump, an outlet of the hydrogen circulation pump is connected to the fifth delivery pipeline through a sixth delivery pipeline, and the sixth delivery pipeline is connected to the inlet of the fuel cell stack through branch pipelines;
the outlet of the hydrogen circulation pump is connected to the outlet of the fuel cell stack through a seventh delivery pipeline;
the fifth delivery pipeline is connected to a hydrogen exhaust pipeline;
a first control valve and a fifth control valve are provided on the sixth delivery pipeline, connection points of the branch pipelines and the sixth delivery pipeline are between the first control valve and the fifth control valve, a second control valve is provided on the seventh delivery pipeline, a third control valve is provided on the first delivery pipeline, and a fourth control valve is provided on the hydrogen exhaust pipeline;
the fuel cell stack comprises three single cells, three injectors are provided correspondingly, and each injector is connected to each single cell;
there are three of the branch pipelines, including a first branch pipeline, a second branch pipeline, and a third branch pipeline; a sixth control valve is provided on the first branch pipeline, a seventh control valve is provided on the second branch pipeline, and an eighth control valve is provided on the third branch pipeline;
the first branch pipeline, the second branch pipeline, and the third branch pipeline are connected to the inlets of the three single cells correspondingly.

2. The fuel cell hydrogen gas circuit device according to claim 1, wherein the third control valve is a pressure reducing valve, the fourth control valve is a hydrogen discharge solenoid valve, and the first control valve, the second control valve, the fifth control valve, the sixth control valve, the seventh control valve, and the eighth control valve are all globe valves.

3. A control method for the fuel cell hydrogen gas circuit device according to claim 1, comprising the following steps:
(1) delivering hydrogen stored in the hydrogen cylinder through the first delivery pipeline to the hydrogen pressure stabilizing chamber, and reducing an inlet pressure to a required outlet pressure when passing through the third control valve;
(2) after stabilizing the pressure through the hydrogen pressure stabilizing chamber, delivering the hydrogen gas to the injector through the second delivery pipeline, and then delivering to the inlet of the fuel cell stack through the third delivery pipeline;
(3) the hydrogen undergoes a chemical reaction in the fuel cell stack, discharging gas after the chemical reaction from the outlet of the fuel cell stack, delivering to the hydrogen-water separator through the fourth delivery pipeline, then delivering the hydrogen separated by the hydrogen-water separator to the injector through the fifth delivery pipeline and converging with the hydrogen transported from the first delivery pipeline, and then supplying to the fuel cell stack;
(4) conducting circulating hydrogen supply when the fourth control valve is closed, and conducting hydrogen discharge when the fourth control valve is opened;
(5) during circulating hydrogen supply, the hydrogen also enters the hydrogen circulation pump through the fifth delivery pipeline; after the hydrogen reaches the hydrogen circulation pump, then supplying the hydrogen at the inlet of the fuel cell stack, at the outlet of the fuel cell stack, or simultaneously at the inlet and the outlet of the fuel cell stack through the sixth delivery pipeline, the seventh delivery pipeline, and switching of the first control valve, the second control valve, the fifth control valve, the sixth control valve, the seventh control valve, and the eighth control valve.

4. The control method for the fuel cell hydrogen circuit device according to claim 3, wherein
A. using a parallel connection of the injector and the hydrogen circulation pump when the fuel cell stack operates at low power, and control steps are as follows:
opening the first control valve, the third control valve, the sixth control valve, the seventh control valve, and the eighth control valve, and closing the second control valve, the fourth control valve, and the fifth control valve;
delivering the hydrogen in the hydrogen cylinder to the injector, and then the hydrogen reaches the inlet of the fuel cell stack, delivering the hydrogen required for reaction to the fuel cell stack; due to high pressure and fast gas flow rate of the hydrogen, a large amount of hydrogen has been discharged from the outlet of the fuel cell stack without reaction and processed through the hydrogen-water separator;
part of the hydrogen separated by the hydrogen-water separator returns to the second inlet of the injector, and is then supplied to the fuel cell stack through the injector; the other part of the hydrogen flows to the hydrogen circulation pump, and the hydrogen is delivered to the outlet of the injector through the hydrogen circulation pump, directly supplying the hydrogen to the fuel cell stack from the inlet of the fuel cell stack without passing through the injector;
B. using a series connection of the injector and the hydrogen circulation pump when the fuel cell stack operates at medium to high power, and control steps are as follows:
opening the first control valve, the third control valve, and the fifth control valve, and closing the second control valve, the fourth control valve, the sixth control valve, the seventh control valve, and the eighth control valve;
delivering the hydrogen in the hydrogen cylinder to the injector, then the hydrogen reaches the inlet of the fuel cell stack, delivering the hydrogen required for the reaction to the fuel cell stack, and the hydrogen discharged from the fuel cell stack is process through the hydrogen-water separator;
part of the hydrogen separated by the hydrogen-water separator returns to the second inlet of the injector, the other part of the hydrogen flows to the hydrogen circulation pump, and the hydrogen is delivered to the inlet of the injector through the hydrogen circulation pump and supplied to the fuel cell stack through the injector;
a switching between the parallel connection and the series connection of the injector and the hydrogen circulation pump follows the following steps:
connecting the fuel cell stack to a sensor module, and connecting the sensor module to a fuel cell controller; the sensor module collects signals from the fuel cell stack and transmits the signals to the fuel cell controller through communication, and the fuel cell controller determines whether the fuel cell stack operates at the low power or the medium to high power; when an output power of the fuel cell stack is w₁ and a peak power is w₂, and when 0<w₁<40% w₂, the fuel cell stack operates at the low power; when w₁>40% w₂, the fuel cell stack operates the medium to high power; for the low power, choosing the parallel connection of the injector and the hydrogen circulation pump, and for the medium to high power, choosing the series connection of the injector and the hydrogen circulation pump.

5. The control method for a fuel cell hydrogen circuit device according to claim 4, wherein a speed regulation of the hydrogen circulation pump adopts following steps:
a. using the series connection of the injector and the hydrogen circulation pump and the parallel connection of the injector and the hydrogen circulation pump, operating the hydrogen circulation pump at different speeds in a laboratory under different operating conditions, including starting, stopping, loading, and unloading, so as to measure a parasitic power and a vibration noise;
b. selecting hydrogen circulation pump speed with a minimum parasitic power and a minimum vibration noise in each operating condition, and recording a vehicle specific power, a volume specific power, a mass specific power, and an operating power at the corresponding hydrogen circulation pump speed; determining an output layer of a neural network algorithm as the hydrogen circulation pump speed, and an input layer as the vehicle specific power, the volume specific power, the mass specific power, and the operating power at the corresponding hydrogen circulation pump speed, thereby obtaining the trained data-driven model;
c. collecting signals from the fuel cell stack by the sensor module, transmitting the signals to the trained data-driven model through communication, and outputting a speed value of the hydrogen circulation pump based on the signals from the fuel cell stack by the trained data-driven model;
the signal of the fuel cell stack comprises parameters of current, voltage, the vehicle specific power, the volume specific power, and the mass specific power;
d. according to the speed value of the hydrogen circulation pump obtained in step c, controlling the hydrogen circulation pump to reduce or increase the hydrogen circulation pump speed.

6. The control method for the fuel cell hydrogen gas circuit device according to claim 3, wherein circulating hydrogen to the outlet of the fuel cell stack alleviates a phenomenon of hydrogen starvation under loading conditions, and control steps are as follows:
when a fuel cell vehicle is in the loading condition, the phenomenon of hydrogen starvation caused by insufficient or untimely hydrogen reaction due to a rapid rise of the load, opening the second control valve and the third control valve, and closing the first control valve, the fourth control valve, the fifth control valve, the sixth control valve, the seventh control valve, and the eighth control valve, so that all the hydrogen flowing to the hydrogen circulation pump is supplied to the outlet of the fuel cell stack through the seventh delivery pipeline, allowing the hydrogen in an internal flow channel of the fuel cell stack to stay longer and react more fully to cope with the loading condition.

7. The control method for the fuel cell hydrogen gas circuit device according to claim 3, wherein an uneven distribution of water on a proton exchange membrane is solved and water flooding is alleviated by circulating hydrogen supply, and control steps are as follows:
when there is a shortage of water at the inlet of the fuel cell stack and water accumulation at the outlet of the fuel cell stack due to gas purging, resulting in local membrane dryness and local flooding in a fuel cell, closing the first control valve, the third control valve, the fourth control valve, the fifth control valve, the sixth control valve, the seventh control valve, and the eighth control valve, and opening the second control valve to reduce a hydrogen flow rate at the inlet of the fuel cell stack, and the residual hydrogen in the hydrogen gas circuit device is used to supply hydrogen at the outlet of the fuel cell stack, increasing hydrogen purging from the outlet to the inlet, so that the water accumulation at the outlet of the fuel cell stack is supplemented to an upper portion of the proton exchange membrane lacks water at the inlet;
when flooding is caused by a large amount of water accumulation generated by the reaction or by delayed drainage, closing the second control valve, the third control valve, the fourth control valve, and the fifth control valve, and opening the first control valve, the sixth control valve, the seventh control valve, and the eighth control valve, stopping the active hydrogen supply, supplying hydrogen separately to the inlet of the fuel cell stack through the hydrogen circulation pump, utilizing a purging effect of the circulating hydrogen at the inlet of the fuel cell stack to discharge excess water inside the fuel cell stack.

8. The control method for the fuel cell hydrogen gas circuit device according to claim 3, wherein residual hydrogen inside the hydrogen gas circuit device is used to alleviate catalyst platinum poisoning and platinum degradation, and control steps are as follows:
when the platinum catalyst poisoning or the platinum degradation occurs, closing the third control valve, the fourth control valve, and the fifth control valve, opening the first control valve, the second control valve, the sixth control valve, the seventh control valve, and the eighth control valve, and utilizing the hydrogen inside the hydrogen gas circuit device to supply hydrogen to the inlet and the outlet of the fuel cell stack; at the same time, stopping oxygen supply to a cathode side of the fuel cell, so that the fuel cell only supplies hydrogen, and a catalyst inside the fuel cell is in an uniform and sufficient hydrogen environment to restore the platinum degradation.
